(19) United States
(12) Patent Application Publication
(10) Pub. No.: US 2024/0283792 A1
(43) Pub. Date: Aug. 22, 2024

(54) ANALYSIS APPARATUS, ANALYSIS METHOD, AND NON-TRANSITORY COMPUTER READABLE MEDIUM

(71) Applicant: NEC Corporation, Minato-ku, Tokyo (JP)

(72) Inventors: Shohei MITANI, Tokyo (JP); Hirofumi UEDA, Tokyo (JP); Nakul GHATE, Tokyo (JP)

(73) Assignee: NEC Corporation, Minato-ku, Tokyo (JP)

(21) Appl. No.: 18/025,162

(22) PCT Filed: Mar. 23, 2022
(86) PCT No.: PCT/JP2022/013742

§ 371 Date: Mar. 7, 2023

(51) Int. Cl. H04L 9/40

(52) U.S. Cl. CPC H04L 63/10

(57) ABSTRACT

An analysis apparatus according to an example embodiment of the present disclosure includes at least one memory configured to store instructions and at least one processor configured to execute the instructions to: acquire at least a data set in which a plurality of combinations of a first pattern of one or more elements indicating attributes of access and an action of access control corresponding to the first pattern are defined, and a second pattern of one or more elements indicating attributes of access that change over time; evaluate an execution cost when an action corresponding to the second pattern is changed over time by using at least transition information indicating a state transition in the one or more elements indicating attributes of access, and the second pattern; and determine the action corresponding to the second pattern by using at least a result of the evaluation and the data set.

### TECHNICAL FIELD

The present invention relates to an analysis apparatus, an analysis method, and a non-transitory computer readable medium.

### BACKGROUND ART

Access control in a network is important for a network security and maintenance of necessary access.

For example, Patent Literature 1 discloses a method for dynamically managing access to assets such as electronic documents or hardware parts using policies that include one or more dynamic access controls linked to a data source such as a database or a web service.

### CITATION LIST

### Patent Literature

Patent Literature 1: Japanese Unexamined Patent Application Publication No. 2012-009027

### SUMMARY OF INVENTION

### Technical Problem

In access control, it is assumed that information about access attributes, such as a position of a device that executes access, and an application to be used, changes frequently. In such a case, the access attributes may change before an access control apparatus determines, based on a policy, an action corresponding to the acquired information about the access attributes and performs control regarding the action. In this case, even when a preferred action for the changed access attributes is defined by the original policy, the processing of the access control apparatus may not keep up with the change in the access attributes, and thus the preferred action may not be implemented. In order to avoid the above situation, when it is attempted to increase the speed of the processing of the access control apparatus, it is necessary to collect pieces of access attribute information or make a determination of the action more frequently. Therefore, there is a concern that the execution cost of the access control may increase.

The present disclosure provides an analysis apparatus, an analysis method, and a non-transitory computer readable medium capable of contributing, in access control, to an increase of the feasibility of an action determined by a policy.

### Solution to Problem

An analysis apparatus according to an example embodiment includes: acquisition means for acquiring at least a data set in which a plurality of combinations of a first pattern of one or more elements indicating attributes of access and an action of access control corresponding to the first pattern are defined, and a second pattern of one or more elements indicating attributes of access that change over time: evaluation means for evaluating an execution cost when an action corresponding to the second pattern is changed over time by using at least transition information indicating a state transition in the one or more elements indicating attributes of access, and the second pattern; and determination means for determining the action corresponding to the second pattern by using at least a result of the evaluation by the evaluation means and the data set.

An analysis method according to an example embodiment is an analysis method executed by a computer, the analysis method including: acquiring at least a data set in which a plurality of combinations of a first pattern of one or more elements indicating attributes of access and an action of access control corresponding to the first pattern are defined, and a second pattern of one or more elements indicating attributes of access that change over time: evaluating an execution cost when an action corresponding to the second pattern is changed over time by using at least transition information indicating a state transition in the one or more elements indicating attributes of access, and the second pattern; and determining the action corresponding to the second pattern by using at least a result of the evaluation and the data set.

A non-transitory computer readable medium according to an example embodiment causes a computer to: acquire at least a data set in which a plurality of combinations of a first pattern of one or more elements indicating attributes of access and an action of access control corresponding to the first pattern are defined, and a second pattern of one or more elements indicating attributes of access that change over time: evaluate an execution cost when an action corresponding to the second pattern is changed over time by using at least transition information indicating a state transition in the one or more elements indicating attributes of access, and the second pattern; and determine the action corresponding to the second pattern by using at least a result of the evaluation and the data set.

### Advantageous Effects of Invention

According to the present disclosure, it is possible to provide an analysis apparatus, an analysis method, and a non-transitory computer readable medium capable of contributing, in access control, to an increase of the feasibility of an action determined by a policy.

### BRIEF DESCRIPTION OF DRAWINGS

FIG. 1 is a block diagram showing an example of an analysis apparatus according to a first example embodiment;

FIG. 2 is a flowchart showing an example of typical processing of the analysis apparatus according to the first example embodiment;

FIG. 3 is a block diagram showing an example of an access control system according to a second example embodiment;

FIG. 4A is a diagram showing an example of a state space;

FIG. 4B shows an example of a table in which actions in each area are defined in a determination sample;

FIG. 5A is a diagram showing an example of an access control situation;

FIG. 5B shows an example of a table in which actions in each area are defined in a determination sample;

FIG. 5C is a diagram showing an example of an action determined by a determination unit;

FIG. 5D shows an example of action control performed in a situation shown in FIG. 5A;

FIG. 6 is a block diagram showing an example of an access control system according to a third example embodiment;

FIG. 7A is a diagram showing an example of an access control situation; FIG. 7B is a graph showing an example of a band usage rate in radio communication performed by a robot;

FIG. 7C is a graph showing an example of action control performed in a situation of FIG. 7A;

FIG. 7D is a graph showing an example of action control performed in the situation of FIG. 7A; and

FIG. 8 is a block diagram showing an example of a hardware configuration of an apparatus according to each of the example embodiments.

### EXAMPLE EMBODIMENT

Example embodiments will be described hereinafter with reference to the drawings. Note that, for the clarification of the description, the following descriptions and the drawings are partially omitted and simplified as appropriate. Further, in the present disclosure, unless otherwise specified, when it is defined “at least one item” of a plurality of items, this may mean any one of or any number of the plurality of the items (including all the items).

### First Example Embodiment

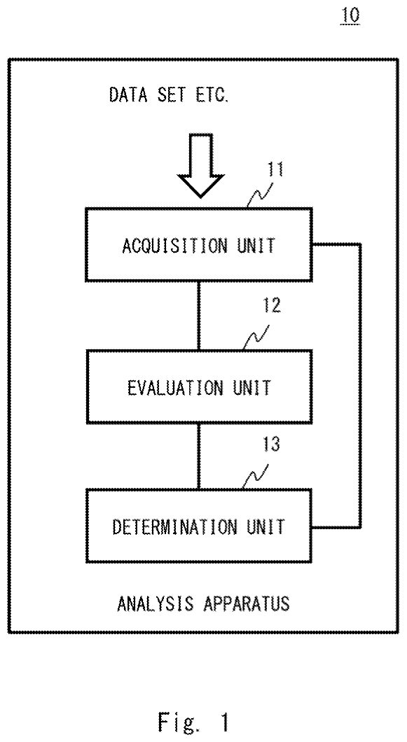

FIG. 1 is a block diagram showing an example of an analysis apparatus. An analysis apparatus 10 includes an acquisition unit 11, an evaluation unit 12, and a determination unit 13. Each of the units (means) of the analysis apparatus 10 is controlled by a control unit (a controller), which is not shown. The aforementioned units will be described below.

The acquisition unit 11 acquires at least a data set in which a plurality of combinations of a first pattern of one or more elements indicating attributes of access and an action of access control corresponding to the first pattern are defined, and a second pattern of one or more elements indicating attributes of access that change over time. There may be just one first pattern and just one second pattern, or there may be a plurality of each of these patterns. Note that the acquisition unit 11 is composed of an interface for acquiring information from inside the analysis apparatus 10 or outside the analysis apparatus 10. Acquisition processing may be performed automatically by the acquisition unit 11 or by a manual input.

Note that, “elements indicating attributes of access” in the first and the second patterns indicate any elements that specify the property of access. Specific examples of the elements may include any one or more of specific information pieces (values) related to the property of access, such as (1) various types of data of an access source, (2) various types of data of an access destination, and (3) data indicating the property of access other than (1) and (2).

Specific examples of (1) various types of data of an access source include any one or more of information about IDentification (ID) of the access source, information about a user, information about a device of the access source, information about an Internet Protocol (IP) address of the access source, information about a port number, software name (e.g., application name), authentication means of the access, and the like. Note that the information about ID of the access source includes any one or more of ID (user ID) of the access source, a user name, a device ID, an application ID, a user authentication result (authentication history) of the ID of the access source, and the like. The information about a user includes any one or more of an affiliation (an organization) of the user, a job title of the user, a job category of the user, a user position (or a position of the device of the access source), an affiliation of the device of the access source, a degree of a behavioral anomaly of the user or the device of the access source, and the like. The information about a device of the access source includes any one or more of an Operating System (OS) version used by the device of the access source and a manufacturer name. The information about an IP address of the access source includes any one or more of the IP address of the access source, a degree of danger of the IP address of the access source, and the like. In the above, the OS version indicates a vulnerability in the access, and the degree of behavioral anomaly indicates possible attacks.

Specific examples of (2) various types of data of an access destination include any one or more of information about ID of the access destination, information about data of the access destination, an IP address of the access destination, information about an OS used by a device of the access destination, an operation type, and the like. The information about ID of the access destination includes any one or more of a resource ID of the access destination, an owner name of the resource ID of the access destination, and the like. The information about data of the access destination includes any one or more of an organization of the access destination (an organization that owns the resource), a type of data (resource) of the access destination to be requested, a creator of the data, the date and time of creation of the data, a degree of confidentiality of the data, and the like. The degree of confidentiality of the resource indicates damage that is expected in the case of an attack.

Specific examples of (3) data indicating the property of the access other than (1) and (2) include any one or more of a frequency of requests from the ID of the access source to the resource ID of the access destination, a time period (or a time) of the access, a mode of a session key, importance of the resource for a requesting subject, a band usage rate (a degree of shortage of radio resources), a degree of an anomaly, an encryption strength of traffic, various types of data related to authentication, and the like. The various types of data related to authentication include any one or more of various types of authentication methods (including, for example, information about authentication strength), a device authentication result, an application authentication result, various authentication times, the number of times of failures of various types of authentication, and the like. The importance of the resource for a requesting subject indicates usability of the resource regarding access, and a band usage rate indicates a potential deterioration in performance that occurs when a plurality of accesses are controlled. However, the elements described above are merely examples, and the elements indicating the attributes of access are not limited to them.

A “pattern of one or more elements indicating attributes of access” means that there are one or more of these elements. For example, it is assumed that X, Y, and Z are attributes of access, X1 and X2 are elements of the same attribute X having different values, Y1 and Y2 are elements of the same attribute Y having different values, and Z1 and Z2 are elements of the same attribute Z having different values. In this case, any one or more of “X1”, “Y1”, “Z1”, “X1, Y1”, “X1, Z1”, “Y1, Z1”, “X1, Y2”, . . . “X1, Y1, Z1” . . . “X2, Y2, Z2” are included as the “pattern of one or more elements indicating attributes of access”. Note that, regarding the elements composing the first pattern and the elements composing the second pattern, at least one or more of the elements of the first pattern may be different from the elements of the second pattern.

A data set acquired by the acquisition unit 11 further includes actions of access control respectively corresponding to the first patterns. Two or more stages of different actions are defined for this action. For example, two or more types of actions among an authorization, a denial, and a conditional authorization (an additional authentication request) may be defined. However, the actions described above are merely examples, and the types of actions are not limited to them.

A plurality of combinations of the first patterns of one or more elements indicating the attributes of the access described above and the actions of access control respectively corresponding to the first patterns are defined in the data set. For example, when there are “X1, Y1”, “X1, Z1”, and “Y1, Z1” as patterns of a plurality of elements indicating the attributes of access and there are “authorization”, “denial”, and “authorization” as actions respectively corresponding to these patterns, “X1, Y1->authorization”, “X1, Z1->denial”, and “Y1, Z1->authorization” are defined in the data set as combinations of the above patterns and actions.

The evaluation unit 12 evaluates an execution cost when the action corresponding to the second pattern is changed over time by using at least transition information indicating a state transition in one or more elements indicating the attributes of the access and the second pattern acquired by the acquisition unit 11. The transition information may indicate, for example, transition states of one or more elements over time indicating the attributes of the access in the second pattern. Alternatively, the transition information may indicate a transition state of an element over time, which is relevant to one or more elements indicating the attributes of the access in the second pattern. The evaluation unit 12 evaluates an execution cost when the action corresponding to the second pattern is changed over time by using, in particular, the above transition state of the element indicated by the transition information. Note that the transition information may be generated by the evaluation unit 12 based on the data or acquired by the evaluation unit 12.

Further, the “execution cost” refers to any cost incurred when a specific action is executed or any cost required to execute a specific action, at least on hardware, software, or a system. Specific examples of the execution cost include a period of time required for processing, the occupancy amount of hardware such as memory and processor, power consumption, an occupancy rate of the communication band, required processing power such as response speed, and the like. However, examples of the execution cost are not limited thereto. For example, the aforementioned execution cost is reduced when the same action as the action currently being executed is executed, while it increases when an action different from the action currently being executed is executed.

The determination unit 13 determines an action corresponding to the second pattern using at least a result of the evaluation by the evaluation unit 12 and the data set acquired by the acquisition unit 11. The action determined by the determination unit 13 may be an action taken at one certain timing or actions respectively taken at two or more timings with time intervals between them. The action to be determined is one action in two or more stages of different actions, and, for example, one of an authorization, a denial, and a conditional authorization (an additional authentication request) is determined as the action.

The determination unit 13 may use Artificial Intelligence (AI) model trained in advance in the determination of an action. In this case, by inputting a result of the evaluation and the data set to the trained AI model, the AI model outputs the action corresponding to the second pattern. However, the determination unit 13 may determine the action corresponding to the second pattern by analyzing a result of the evaluation and the data set using another algorithm.

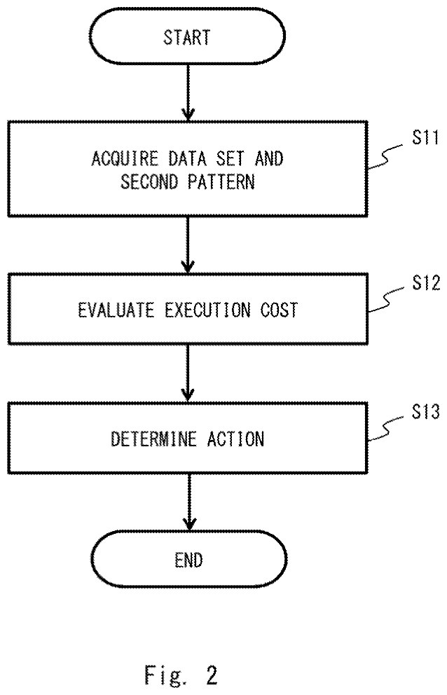

FIG. 2 is a flowchart showing an example of typical processing of the analysis apparatus 10. This flowchart describes the processing of the analysis apparatus 10. Note that details of each processing are as described above.

First, the acquisition unit 11 of the analysis apparatus 10 acquires at least a data set in which a plurality of combinations of a first pattern of one or more elements indicating attributes of access and an action of access control corresponding to the first pattern are defined, and a second pattern of one or more elements indicating attributes of access that change over time (Step S11: an acquisition step).

Next, the evaluation unit 12 evaluates an execution cost when an action corresponding to the second pattern is changed over time by using at least transition information indicating a state transition in the one or more elements indicating attributes of access, and the second pattern (Step S12: an evaluation step). Then, the determination unit 13 determines the action corresponding to the second pattern by using at least a result of the evaluation by the evaluation unit 12 and the data set (Step S13: a determination step).

As described above, in the first example embodiment, the evaluation unit 12 evaluates an execution cost in the second pattern, and the determination unit 13 uses the execution cost when it determines the action corresponding to the second pattern. This configuration prevents a situation from occurring in which the determination unit 13 determines an action for which a high execution cost is incurred. Therefore, the analysis apparatus 10 can contribute, in access control, to an increase of the feasibility of an action determined by a policy.

### Second Example Embodiment

A second example embodiment will disclose below a specific example of the analysis apparatus 10 described in the first example embodiment.

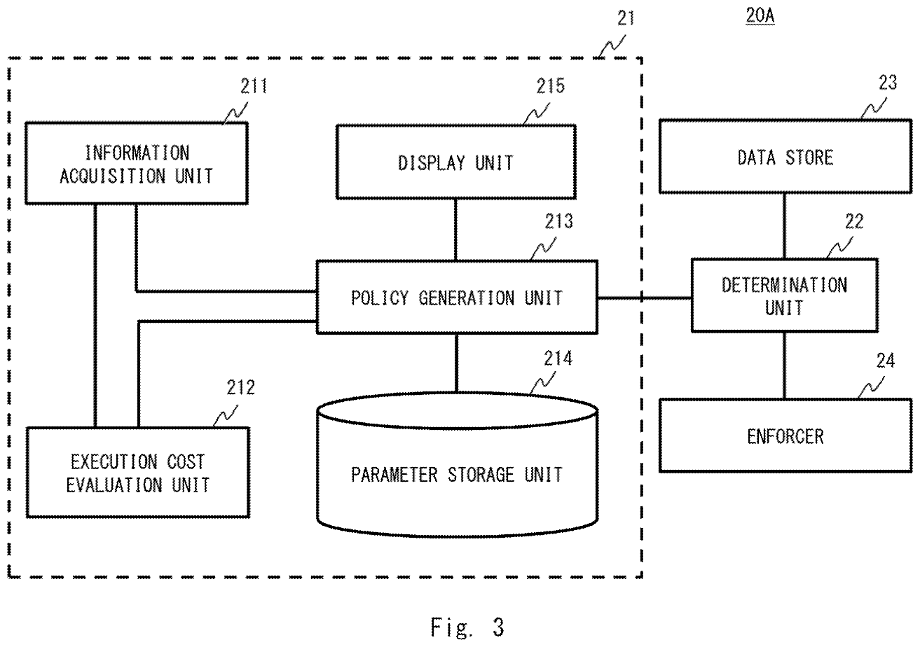

FIG. 3 is a block diagram showing an example of an access control system 20A that performs a determination of access control on a zero-trust network. The access control system 20A includes a policy generation system 21, a determination unit 22, a data store 23, and an enforcer 24. Details of each unit will be described below.

The policy generation system 21 corresponds to a specific example of the analysis apparatus 10 according to the first example embodiment. The policy generation system 21 generates, based on information to be input, an access control policy for access control, and outputs the generated access control policy to the determination unit 22. The information to be input may include information other than a determination sample (corresponding to the data set in the first example embodiment) and transition information indicating a state transition of attribute information. Details of the aforementioned policy generation system 21 will be described later.

Note that an access control policy is a policy in which a plurality of combinations of one or more patterns indicating the attributes of access and actions of access control respectively corresponding to the one or more patterns are defined. As a specific example, when the combination of elements is (Position of the device which is the access source: A, Type of the resource: Resource A), the action corresponding the access control policy may be defined as an “authorization”.

When an inquiry (request) about access control is made, the determination unit 22 acquires attribute information related to the element of the request from the enforcer 24 or the like. Then the determination unit 22 determines an action corresponding to the request by using the acquired attribute information and the access control policy generated by the policy generation system 21. In other words, the determination unit 22 functions as a policy engine. The element related to the request means an element the same as the element indicating the attributes of access described in the first example embodiment.

Specifically, as elements related to the request, (i) attribute information of the element indicating the attributes of access included in the request acquired from the enforcer 24 and (ii) background attribute information stored in the data store 23 are input to the determination unit 22. Examples of the information (i) may include ID of the access source, an IP address of the access source, a resource ID of the access destination, an operation type, a session key, and the like. However, the information of the elements included in the request is not limited thereto. Further, the information (ii) may be any information about devices, users, applications, networks, and resources in the system, or other threat information or environmental information. Specific examples of the information (ii) may include a user name of the ID of the access source, an affiliation, a job title, and a job category of a user, a manufacturer name of the device, a position of the device which is the access source, a user position, a user authentication result, a degree of danger of the IP address of the access source, an owner name of the resource ID of the access destination, a type of data of the access destination, the date and time of creation of the data, encryption strength, a frequency of requests from the ID of the access source to the resource ID of the access destination, a time of the access, various types of authentication methods, a device authentication result, an application authentication result, times of various authentications, the number of times of failures of the various authentications, and the like. However, the information of the elements included in the background attribute information is not limited thereto. Further, information about a result of at least either a risk assessment or a needs (or usability) assessment made using the above background attribute information may be further included as the information (ii). The risk indicates a risk related to security, for example, a risk in which access is used for unauthorized access (attack). Note that the determination unit 22 may use both (i) and (ii) or only (i) when an action is determined.

The determination unit 22 compares the elements related to the request with a combination of a plurality of elements defined in the access control policy, thereby specifying a combination of the elements defined in the access control policy that satisfies the conditions of the elements related to the request. Then the determination unit 22 determines, as the action for the request, the action which is defined so as to correspond to each combination, and outputs information about the determined action to the enforcer 24.

Actions that can be used in the second example embodiment include, but are not limited to, an authorization, an additional authentication request, a manual authorization request, a transfer to a detailed analysis engine, a denial, etc. Examples of the actions may include transfer of access to a server that performs more detailed checks, an approval request to an administrator, and the like. These actions constitute a totally ordered set that satisfies reflexive, transitive, antisymmetric, and perfect laws. Further, in this example embodiment, for the pattern, a totally ordered set indicating the degree of influence on the action is specified. Note that the direction toward “authorization” or “denial” is defined as an “order of degree of influence”, and information indicating how much an action moves toward “authorization” or “denial” is defined as a “magnitude of degree of influence”

The determination unit 22 may further calculate data (e.g., reliability of the access source) that is a parameter related to the request but is not included in the acquired elements. When the determination unit 22 calculates the reliability, the determination unit 22 functions as a trust engine.

Further, the determination unit 22 may determine an action by a method other than the method for determining an action for an individual request and outputting the action to the enforcer 24. The determination unit 22 can determine actions for IDs of various types of (a plurality of) request sources or request destinations at one time using the access control policy generated by the policy generation system 21 before a request is made, and output them. The set of the plurality of output actions can be output as an Access Control List (ACL) to the enforcer 24 that performs access control on the request. When the enforcer 24 receives a request, the enforcer 24 can determine an action for the request by using this ACL without making an inquiry to the determination unit 22.

The determination unit 22 can be implemented by any means such as a proxy server for access control, an application gateway, and an Attribute-based Encryption (ABE). The determination unit 22 can achieve determination of an action by any means such as a decision tree, a linear model, and a neural network. Further, when the determination unit 22 calculates the reliability, the calculation of the reliability can be achieved by any means such as naive Bayes, fuzzy logic, and a weighted sum.

The data store 23 is a storage (a storage unit) in which background attribute information used in the determination unit 22 is stored. The access control system 20A stores automatically collected pieces of data in the data store 23. When a request for access control is made, the determination unit 22 acquires background attribute information corresponding to the request by referring to the data store 23. The background attribute information stored in the data store 23 may be any information about devices, users, applications, networks, and resources in the system, or other threat information or environmental information, and may include information about a result of at least either a risk assessment or a needs assessment made using the above information.

The data store 23 may be implemented by, for example, an asset management function, an authentication and ID management infrastructure, a workpiece load monitoring function, and a threat information infrastructure, or functions such as a user behavior log, Continuous Diagnostics and Mitigation (CDM), and Security Information and Event Management (SIEM).

When the enforcer 24, which is an access control device provided on a user network, receives an access control request, it outputs information about elements related to the request (information about access attributes) to the determination unit 22. Then the enforcer 24 acquires information of the action determined by the determination unit 22, and performs access control for the request based on the information of the action. When access is authorized, the enforcer 24 forwards the packets for the access to the resource (the access destination), while when access is denied, the enforcer 24 discards the packets for the access. Further, it can be assumed that there are actions of types other than an authorization or a denial. As an example, the enforcer 24 may forward the access to a detailed analysis engine (not shown). By the detailed analysis engine performing a detailed analysis of the access, either an authorization or a denial is determined as an action for the access. As described above, the access control system 20A performs access control based on the generated access control policy.

As another example, the enforcer 24 may acquire an ACL, which is a set of actions, from the determination unit 22 as described above. In this case, when the enforcer 24 receives a request, the enforcer 24 can determine an action for the request by referring to the ACL and then specifying the action corresponding to the request without making an inquiry to the determination unit 22.

The enforcer 24 may be implemented by functions such as a reverse proxy, a firewall, a gateway, and an attribute-based encryption infrastructure.

Next, the details of the policy generation system 21 will be described. As shown in FIG. 3, the policy generation system 21 includes an information acquisition unit 211, an execution cost evaluation unit 212, a policy generation unit 213, a parameter storage unit 214, and a display unit 215. Each of the units will be described below.

The information acquisition unit 211 acquires information for the policy generation unit 213 to generate a policy described later. The information acquisition unit 211 is configured as, for example, an input unit that inputs information.

The information acquisition unit 211 acquires a pattern (corresponding to the second pattern according to the first example embodiment and hereinafter referred to as a target pattern) of one or more elements indicating the attributes of access that change over time, which pattern is a target of a policy generation, and information for the policy generation. The information for the policy generation includes, for example, a determination sample. The determination sample includes a plurality of sample policies defined by a user (or an existing automation method). The sample policy is a policy in which a plurality of corresponding relations between a pattern of a plurality of elements indicating the attributes of access (hereinafter also referred to as a sample pattern) and an action of access control for the sample pattern are defined. Since actions are uniquely determined, such as an authorization and a denial, as described above, quantitative information for generating policies is defined in the determination sample. Note that a corresponding relation between only one element and the action of access control for this element may be defined in the sample policy. As the number of sample policies required for policy generation is reduced, the efforts to design policies can be reduced.

Note that a plurality of sample policies may be defined from perspectives different for each individual policy. For example, elements such as an encryption strength of traffic, an OS version of the device of the access source, an application authentication result, an authentication strength of a user, a creator of the resource, and the type of the resource may be set as perspectives based on the security function. Further, as perspectives based on an organizational department structure (an affiliation, a job title, etc.) in the access, elements such as a job title and an affiliation of a user (e.g., a project in charge), a creator of the resource, a type of the resource, a user position, and a position of the device of the access source may be set. As described above, different perspectives may have different elements or the same elements. Specific examples of the sample policy include “an affiliation and a position of the device which is the access source->authorization/denial”.

Further, the sample policy may be expressed in such a form that some of the elements cannot be uniquely identified (namely, they are “anonymized”). An affiliation of a user in the sample policy is expressed as, for example, a “human resources department” or a “development department” in a non-anonymized state, while it is expressed as an “A department” or a “B department” in an anonymized state. The above anonymization is done, for example, to protect the organization's confidential information when the sample policy is presented to people and systems outside the organization. Alternatively, it can be assumed that the above anonymization is done since the elements of basic data have not been uniquely identified (e.g., the readability of basic data has been low) when the sample policy is originally generated.

The information acquisition unit 211 may output the acquired determination sample as it is to the execution cost evaluation unit 212 and the policy generation unit 213. Alternatively, the information acquisition unit 211 may further acquire data indicating ideal access control for a specific pattern and output the data as a determination sample to the execution cost evaluation unit 212 and the policy generation unit 213. For example, this data may include several to dozens of patterns. However, the number of patterns included in this data is not limited thereto. By the above configuration, the accuracy of a policy generated by the policy generation unit 213 can be further improved.

Note that the information acquisition unit 211 can also acquire correction information related to a correction of the access control policy, which is input by a user after referring to the display unit 215 described later and then making a determination. The information acquisition unit 211 outputs the correction information to the policy generation unit 213. Further, the determination sample acquired by the information acquisition unit 211 may be changed by a user as appropriate.

Further, the information acquisition unit 211 may acquire an intention (a third pattern) that is expected to be used by a decision maker when an action is determined based on one or more elements. The intention means knowledge required for policy generation and, more specifically, includes a pattern of one or more elements indicating the attributes of access.

The information acquisition unit 211 may, as the intention, acquire an intention in which at least one of the order and the magnitude of degree of influence of the intention on the action is defined so as to correspond to a pattern of one or more elements. Further, as described below, the above intention is allowed to be defined by an ambiguous form. The information acquisition unit 211 can acquire any number of the above combinations greater than or equal to one.

Examples of the pattern of one or more elements may include a set of “a position of the device of the access source and a type of requested data or an organization that owns the resource”, a set of an “OS and a software name or an application name”, a single “affiliation of the device of the access source”, and a single “degree of an anomaly”. For example, in access control, a type of data for which access is authorized or an organization that owns the resource may vary depending on the affiliation (or the position) of the device of the access source. Therefore, an “affiliation of a user and a type of requested data or an organization that owns the resource” may be defined as an element of the intention. Similarly, in access control, since it is expected that the security level of access may change (i.e., an authorization or a denial of the access may change) depending on a combination of an OS and software or an application of the access source, an authentication method, and a degree of an anomaly, an “OS and a software name or an application name”, an “authentication method”, and a “degree of an anomaly” may be defined as elements of the intention.

Further, information about the degree of influence of the intention on the action is information that indicates how much the action moves in either the direction of “authorization” or “denial”. As described above, the direction toward “authorization” or “denial” is defined as an “order of degree of influence” and information indicating how much an action moves toward “authorization” or “denial” is defined as a “magnitude of degree of influence”. For example, the “order of degree of influence” is the descending order of “magnitudes of degree of influence”. This information about the degree of influence does not need to indicate an action itself to be executed.

Note that the information acquisition unit 211 may acquire data such as numerical values expressed quantitatively or information in a qualitative (ambiguous) form as the degree of influence in the intention. Specific examples of the information in a qualitative (ambiguous) form include information such that, for example, in regard to the direction (the positive direction) of an action toward “authorization”, “Position of the device of the access source: A, Requested data: Resource A” is greater than “Position of the device of the access source: A, Requested data: Resource B”. Note that the device of the access source is an apparatus (a drone in this example) that performs communication while moving, and the resources A and B are surrounding map data regarding the flight in an area A and surrounding map data regarding the flight in an area B, respectively. When a drone flies in an area, it is natural to acquire map data regarding the area in order to fly safely, and it is considered reasonable that access control regarding it be authorized. Therefore, when the position of the device of the access source coincides with a target area of requested data, or when the position of the device of the access source is close to a target area of requested data, it is preferable that an action be “authorized”. However, from a security perspective, it may be undesirable for a drone to acquire map data for areas that differ from areas it currently flies. Therefore, an action in the case of “Position of the device of the access source: A, Requested data: Resource A” is more likely to be “authorized” than an action in the case of “Position of the device of the access source: A, Requested data: Resource B”.

As other examples, for parameters such as the newness of a version of the OS of the access source, the degree of lowness of a behavioral anomaly of the device of the access source, and the degree of disclosure (the degree of lowness of confidentiality) of a type of the resource of the access destination, the degree of influence may be set so that the higher the value, the greater the direction of the action toward “authorization”. Further, the degree of influence may be set so that for a user who is permitted based on the access authority created by an owner (a resource owner) of the resource ID of the access destination, an action for this resource is in the direction toward “authorization”. Note that, in the above example, although the direction (the positive direction) of an action toward “authorization” has been described, the direction (the negative direction) of an action toward “denial” can be similarly defined.

As described above, the degree of influence is qualitative information that indicates a general trend, unlike information in a quantitative form that indicates an actual authorization or denial. Note that the magnitude of the degree of influence may be expressed in three or more levels (e.g., in a descending order of the degree of influence, expressions such as “a high degree of influence”, “a slightly high degree of influence”, and “a low degree of influence” can be used) instead of being expressed in two levels. The qualitative information can be determined, for example, by a user who determines access control.

When the information acquisition unit 211 acquires the above qualitative information about the degree of influence, it can change the information about the degree of influence to a numerical value in which the order and magnitude of the degree of influence are defined, and then output it to the policy generation unit 213. For example, when a positive score is assigned as the direction of “authorization”, an action in the case of “Affiliation of User: Development department, Requested data: Design data” is more likely to be “authorized” than an action in the case of “Affiliation of User: Development department, Requested data: Personnel data”, and therefore the information acquisition unit 211 may assign a numerical value of the degree of influence “1” to the former and the degree of influence “0” to the latter.

The execution cost evaluation unit 212 generates a model (a state transition model: an example of transition information according to the first example embodiment) related to the time change of attribute information in one or more elements indicating the attribute of access, and holds it. A state in the second example embodiment refers to a vector composed of a set of one or more other attribute information pieces when a control unit such as a device ID, a resource ID, and the like is fixed. The execution cost evaluation unit 212 evaluates an execution cost of the action corresponding to a target pattern by using the aforementioned state transition model. The explanation of the execution cost of an action is as described in the first example embodiment. The higher the execution cost of an action, the less desirable it is for it to be executed, while the lower the execution cost of an action, the more desirable it is for it to be executed. Since the policy generation unit 213 generates a policy of the target pattern by using the evaluated execution cost, actions that are difficult to actually control are prevented from being defined by the policy. As a result, it is possible to reduce wasteful execution costs.

For example, the execution cost evaluation unit 212 may construct, by using at least either an attribute information log or design information, a state space of a graph structure connecting states having high transition probabilities to each other by weighted edges. The attribute information log indicates a history of access to attributes changing over time that has been actually done and the corresponding actions. The design information is information in which access to attributes that change over time and the corresponding actions are defined in advance.

As a specific example, it is assumed that the apparatus is an apparatus that performs communication while moving, such as a drone, and that the current position of the apparatus is a state 1 and the position of the apparatus after a unit time has elapsed from now is a state 2. Note that, as the transition probability from the state 1 to the state 2 increases, the distance between the state 1 and the state 2 in the state space is reduced and the weight of the edge in the graph structure increases. For example, as the position of state 1 in the real space becomes closer to the position of state 2 in the real space, the transition probability from the state 1 to the state 2 increases, and therefore the execution cost evaluation unit 212 increases the weight of the edge. As another example, as the band usage rate of the state 1 becomes closer to the band usage rate of the state 2, the transition probability from the state 1 to the state 2 increases, and therefore the execution cost evaluation unit 212 increases the weight of the edge.

At this time, the execution cost evaluation unit 212 (A) smooths the probability of possible actions between the states 1 and 2 in accordance with the weight of the set edge. This process (A) will be described in detail below.

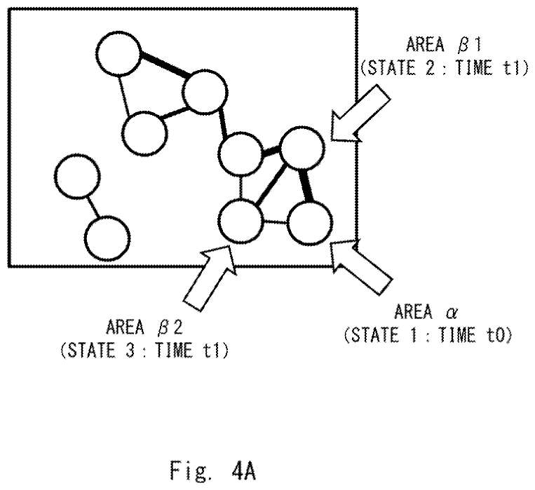

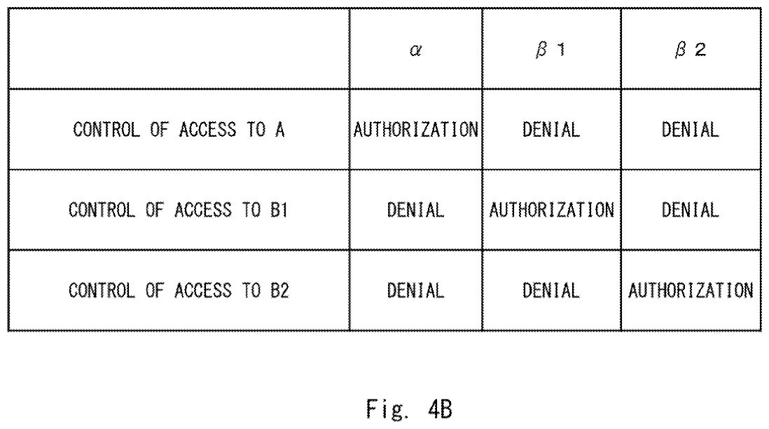

FIG. 4A shows an example of a state space. This state space indicates a state in which a drone R of the access source performs communication while moving. In the state space of FIG. 4A, the drone R is located in an area a at an initial time to and this state is defined as a state 1. Then, at a time t1 when a certain time has elapsed from the initial time to, the drone R can move to either an area β1 or an area β2. A state in which the drone R is located in the area β1 at the time t1 is defined as a state 2, and a state in which the drone R is located in the area β2 at a time t2 is defined as a state 3. Note that, in FIG. 4A, the transition probability from the state 1 to the state 2 is higher than the transition probability from the state 1 to the state 3. Therefore, the execution cost evaluation unit 212 sets the weight of the edge from the state 1 to the state 2 so that it becomes greater than the weight of the edge from the state 1 to the state 3.

FIG. 4B shows an example of a table in which actions in the areas α, β1, and β2 are defined in the determination sample acquired by the information acquisition unit 211 in this example. The resources A, B1, and B2 in the table are map data regarding the flights in the areas α, β1, and β2, respectively, and are data of the access destination. In FIG. 4B, when the drone R flies in the areas α, β1, and β2, although acquisition of map data for each area is authorized, acquisition of map data for areas where the drone R is not currently flying is denied.

The execution cost evaluation unit 212 refers to data of the state space shown in FIG. 4A and data of the determination sample shown in FIG. 4B. The execution cost evaluation unit 212 then determines that the weight of the edge from the state 1 to the state 2 is greater than the weight of the edge from the state 1 to the state 3 (i.e., the transition probability from the state 1 to the state 2 is higher than the transition probability from the state 1 to the state 3). The execution cost evaluation unit 212 evaluates the execution cost of denying access to the resource B1 in the state 1 so that it is higher than the execution cost of denying access to the resource B2 in the state 1 based on a result of the determination. This is because when access to the resource B1 in state 1 is denied, it is necessary to switch control operations of the access to the resource B1 from a denial to an authorization so that, for example, access to the resource B1 is authorized in synchronization with the transition to the state 2. In this case, there is a high probability that the operations will be switched and hence the average execution cost increases. On the other hand, since the transition probability from the state 1 to the state 3 is relatively low, the execution cost associated with the switching of the control operations of the access to the resource B1 is reduced on average.

More specifically, since the drone R is an apparatus that is movable, even though the access control system 20A recognizes that the drone R is in the area a (the state 1), the drone R may actually be in the area β1 (the state 2) or in the area β2 (the state 3). As shown in FIG. 4A, the drone R is more likely to move to the state 2 than the state 3 in the state space. Therefore, when the access control system 20A recognizes that the drone R is in the area α (the state 1), the probability that the drone R will actually be in the area β1 is higher than the probability that the drone R will actually be in the area β2. Further, as shown in FIG. 4B, access to the resource B1 and access to the resource B2 are respectively permitted in the states 2 and 3. Therefore, the execution cost evaluation unit 212 performs the above process so that the possibility that access to the resource B1 will be permitted in the state 1 is higher than the possibility that access to the resource B2 will be permitted in the state 1 in the subsequent policy generation by the policy generation unit 213.

Note that, in the determination sample data shown in FIG. 4B, if the drone R is permitted to acquire a resource B3 (not shown) when it flies in the area β1, the execution cost evaluation unit 212 evaluates the execution cost of denying access to the resource B3 in the state 1 so that it is higher than the execution cost of denying access to the resource B2 in the state 1. Further, in the determination sample data shown in FIG. 4B, it can be assumed that the acquisition of the resource B1 is denied when the drone R flies in the area β1, and the acquisition of the resource B2 is denied when the drone R flies in the area β2. In this case, the execution cost evaluation unit 212 evaluates the execution cost of authorizing access to the resource B1 in the state 1 so that it is higher than the execution cost of authorizing access to the resource B2 in the state 1.

As described above, in the state 1, the execution cost evaluation unit 212 evaluates the execution cost so that the execution cost of executing the action different from the action defined in the determination sample in the state 2 is higher than the execution cost of executing the action different from the action defined in the determination sample in the state 3. The execution cost evaluation unit 212 outputs a result of the evaluation of the execution cost to the policy generation unit 213.

Further, in addition to the process (A), the execution cost evaluation unit 212 can execute the following process (B). (B) As a result of an analysis of the state space, the execution cost evaluation unit 212 generates, regarding an access in which the time interval of the transition of the state from the state 1 to the state 2 is less than or equal to the interval (threshold) of a predetermined allowable time and an action defined in the determination sample in the state 1 differs from an action defined in the determination sample in the state 2, a sample policy that defines the actions corresponding to the access as being the same action (e.g., an authorization or a denial). The fact that the time interval of the transition from the state 1 to the state 2 is less than or equal to the interval of a predetermined allowable time means that the feasibility of changing the action in the state 1 and the state 2 (the feasibility of changing the action over time) is less than a predetermined threshold.

The execution cost evaluation unit 212 determines the same action defined for the states 1 and 2 by using, for example, at least either the determination sample acquired by the information acquisition unit 211 or information about a result of at least either the risk assessment or the needs assessment stored in the data store 23. The risk assessment indicates the level of security required for the access pattern subject to determination for the access control, and the needs assessment indicates the level of needs required for the access pattern subject to determination for the access control.

For example, in the risk assessment, when the risk set in the ID of the drone R is greater than or equal to a predetermined threshold, the execution cost evaluation unit 212 determines actions defined for the states 1 and 2 to be a “denial”. As another example, when the risk set in the ID of the drone R is less than a predetermined threshold in the risk assessment, and the needs set in the ID of the drone R is greater than or equal to a predetermined threshold in the needs assessment, the execution cost evaluation unit 212 determines actions defined for the states 1 and 2 to be an “authorization”. Note that when the risk set in the ID of the drone R is less than a predetermined threshold in the risk assessment and the needs set in the ID of the drone R is less than a predetermined threshold in the needs assessment, the execution cost evaluation unit 212 may determine actions defined for the states 1 and 2 to be either an “authorization” or a “denial”. In this way, the execution cost evaluation unit 212 determines an action in which one of the level of needs and the level of security is satisfied, and newly generates a sample policy in which the determined action is defined.

An additional determination sample policy (hereinafter may be referred to as an additional determination sample) set as described above is input to the policy generation model described below. By this configuration, the policy generated by the policy generation unit 213 is controlled so as to define the same action for the states 1 and 2.

For example, in the example shown in FIG. 4A, it is assumed that the moving speed of the drone R is so high that it is practically difficult to control access by accurately understanding a movement state of the drone R with the access control apparatus. Under the above circumstances, when the determination sample defines that the action is changed in accordance with the position of the drone R, it is not realistic to control access based on this definition, and it is expected that the execution cost will increase. In such a case, the actions determined for the states 1 and 2 are set to be the same action by the process (B), whereby it is possible to reduce the execution cost for access control.

Meanwhile, when the time interval of the transition from the state 1 to the state 2 is greater than the interval of a predetermined allowable time, it means that the feasibility of changing the action in the state 1 and the state 2 is greater than or equal to a predetermined threshold. In this case, the execution cost evaluation unit 212 does not generate an additional determination sample. By this configuration, as described later, the policy generation unit 213 can determine an action so that the needs and the security defined in the needs assessment and the risk assessment in the access pattern subject to access control are satisfied.

Referring back to FIG. 3, the policy generation unit 213 will be described. The policy generation unit 213 acquires a target pattern and information for policy generation such as a determination sample and an intention from the information acquisition unit 211, and acquires a result of the evaluation of the execution cost (and an additional determination sample if it is generated) from the execution cost evaluation unit 212. As described above, the determination sample is information that reflects a quantitative intention for generating a policy. Meanwhile, information for policy generation may include qualitative information such as a positive or a negative effect of any attribute information on the determination of an action as information of the intention. The policy generation unit 213 also acquires information about the risk assessment and needs assessment.

The policy generation unit 213 inputs the above information pieces to a model for generating an access control policy (hereinafter referred to as a policy generation model). The policy generation model has been subjected to machine learning in advance so that it generates an access control policy based on the input. In this way, the policy generation model generates an access control policy in which an action for access control according to the direction indicated by the input information is defined, and outputs it. The access control policy is defined as a combination of the pattern (the target pattern) of one or more elements indicating the attributes of access and an action. The pattern of the elements included in the access control policy may be a sample pattern defined with information for policy generation and an additional determination sample.

Based on the input information, the policy generation model can determine in detail, as an access control policy, the pattern of combination of elements and combination of actions which are not clearly defined by the sample policy (e.g., they have been ignored, since they are out of range or they have no substantial effect on determinations on access control) by emulating the method by which an administrator or the like of the network subject to access control has determined a sample policy. Note that the policy generation model can automatically adjust the combination of the elements based on the intention and the corresponding order and magnitude of degree of influence so that the values thereof become appropriate.

For example, the policy generation model can generate an access control policy so that information about the degree of influence (e.g., the order and magnitude) corresponding to the pattern of elements acquired from the information acquisition unit 211 is stored. That is, the policy generation model can generate an access control policy so that the quantitative action corresponding to the target pattern defined by the access control policy is consistent with the qualitative information about the degree of influence acquired from the information acquisition unit 211. Further, as an example, the generated access control policy may be one that uniquely identifies the anonymized part of the sample policy.

Further, the policy generation model can also generate an access control policy so that the quantitative action corresponding to the target pattern defined by the access control policy is consistent with the result of the evaluation and the additional determination sample output by the execution cost evaluation unit 212.

Further, the policy generation model can change, when the information for policy generation such as the determination sample acquired from the information acquisition unit 211 has changed or when the information such as the result of the evaluation of the execution cost acquired from the execution cost evaluation unit 212 has changed, the generated access control policy in accordance with the change.

Further, when the policy generation unit 213 acquires correction information of the access control policy from the information acquisition unit 211, it can correct the generated access control policy in accordance with the correction information.

The policy generation unit 213 described above can be implemented by any means such as a linear model, a support vector machine, a neural network, a decision tree, an ensemble decision tree, a Bayesian model, a non-negative weight linear model, a monotonic neural network, and a monotonic decision tree.

Further, the policy generation unit 213 may generate some algorithm (e.g., program) instead of an access control policy. When a pattern of a plurality of elements indicating the attributes of a predetermined (e.g., a requested) access is input, this program outputs an action corresponding to the pattern. The policy generation unit 213 outputs the program to the determination unit 22, and the determination unit 22 determines an action regarding the request using the program. The policy generation unit 213 outputs the generated access control policy (or algorithm) to the determination unit 22 and the display unit 215.

The parameter storage unit 214 stores parameters (e.g., parameters necessary to set a policy generation model) necessary for the policy generation unit 213 to generate an access control policy. When the policy generation unit 213 generates an access control policy, it acquires parameters from the parameter storage unit 214.

The display unit 215 is an interface that organizes access control policies generated by the policy generation unit 213 and displays them so that a user can understand them easily. The display unit 215 has display functions such as a Graphical User Interface (GUI) and a Command Line Interface (CLI). Further, the display unit 215 may have an interface such as a computer (e.g., a management cloud server) for a user to manage access control.

For example, the display unit 215 can collectively display, as contents of an access control policy, a situation to be permitted and users and devices to be permitted for each organization that owns the resource of the access destination. At this time, the display unit 215 can omit the display of attribute information of the element in which an influence on an action is less than or equal to a threshold. The display unit 215 can also display an access control policy on a GUI common to the input unit, so that a user can easily recognize the consistency between information such as a determination sample input by the user through the input unit and the access control policy displayed by the display unit 215.

By referring to the display unit 215, a user inputs, through the input unit, correction information about a part of the access control policy which it is not considered is valid. By doing so, the information acquisition unit 211 outputs the correction information to the policy generation unit 213, and then the policy generation unit 213 corrects the part of the access control policy specified by the correction information. Further, when the corrected access control policy is displayed on the display unit 215, a user can confirm the correction of the access control policy.

Further, a user may also input an additional determination sample to the policy generation system 21 through the input unit based on a result of the display of the access control policy on the display unit 215. By doing so, the policy generation unit 213 can generate, by using the additional determination sample acquired by the information acquisition unit 211, an access control policy in accordance with the situation more accurately at the timing when a next or a subsequent access control policy is generated.

The processes performed by the access control system 20A described above will be further described by using a detailed example.

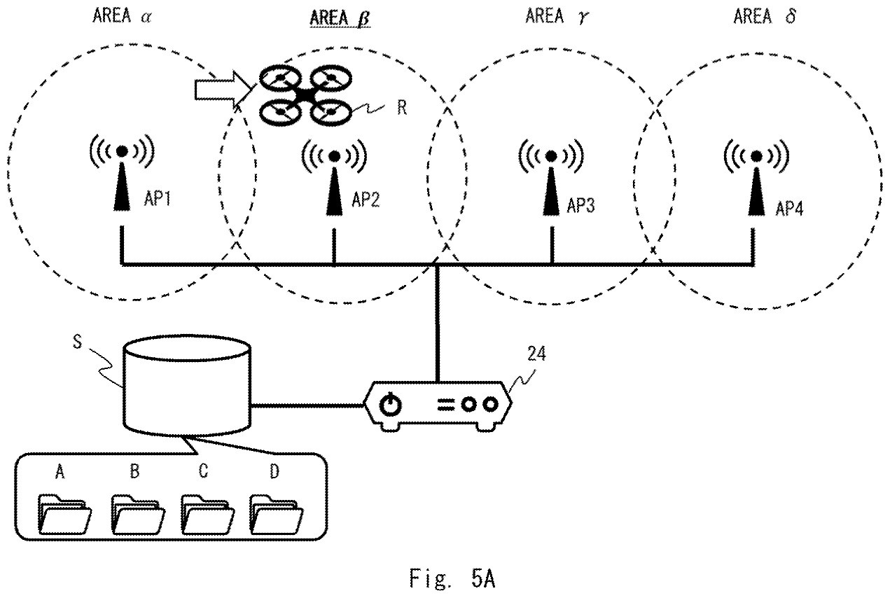

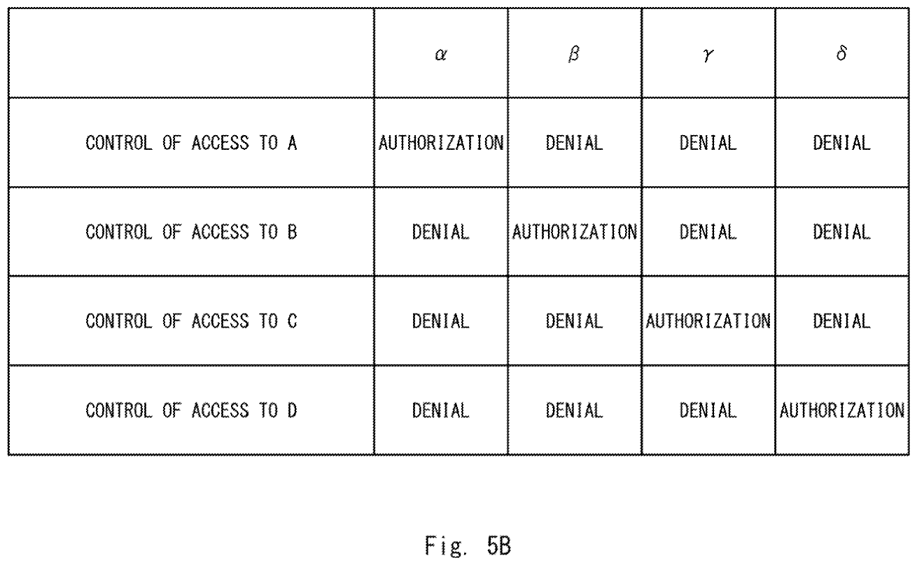

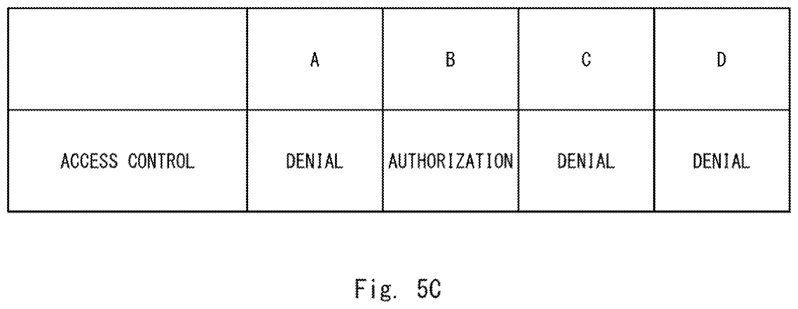

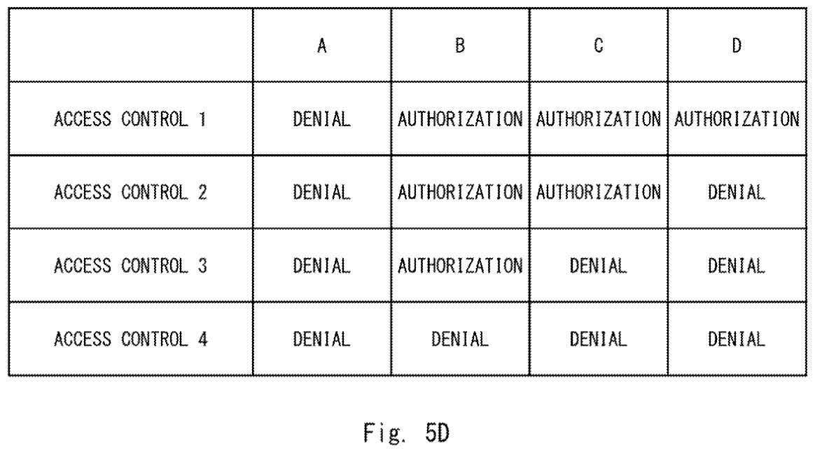

FIG. 5A shows an example of an access control situation. In FIG. 5A, the drone R is moving, i.e., flying, from an area α to an area δ, and in FIG. 5A, it is located in an area β. Each of the areas α to δ is connected to the enforcer 24, which is an access control device, and Access Points (APs) 1 to 4, which enable radio communication with the drone R when the drone R moves to each area α to δ, are provided. When a request for a resource is made from the drone R, the enforcer 24 receives the request from the AP in the area where the drone R is located. When the enforcer 24 receives this request, it outputs the ID of the drone R that is the access source, position information of the drone R (information indicating which area the drone R is in), and the like to the determination unit 22 (not shown in FIG. 5A). The enforcer 24 authorizes or denies access to each of resources A, B, C, and D included in a resource S connected to the enforcer 24 based on an action instruction from the determination unit 22.

FIG. 5B shows an example of a table in which actions in the areas α, β, γ, and δ are defined in the determination sample acquired by the information acquisition unit 211 in this example. The resources A, B, C, and D in the table are data included in the resource S and map data regarding the flights in the areas α, β, γ, and δ, respectively. In FIG. 5B, when the drone R flies in the areas α, β, γ, and δ, although acquisition of map data for each area is authorized, acquisition of map data for areas where the drone R is not currently flying is denied.

FIG. 5C is a diagram showing an example of an action determined by the determination unit 22 when the drone R is located in the area β and the determination sample shown in FIG. 5B is used as an access control policy as it is. As shown in FIG. 5C, although access to the resource B by the drone R is permitted, access to other resources is denied. However, when the moving speed of the drone R is high, it is assumed that the actual position of the drone R may have been moved to a different position (e.g., the area γ or δ) while the enforcer 24 recognizes that the position of the drone R is in the area β. In this case, since the drone R cannot acquire the resource related to the area where the drone R is currently located, the drone R may acquire a resource for the area where it has already finished flying, and hence it may not be possible to control access in accordance with the actual situation.

FIG. 5D shows an example of action control performed in a situation shown in FIG. 5A by the access control policy generated by the policy generation unit 213 based on the above process. In FIG. 5D, examples of four types of access controls 1 to 4 are shown as action controls in accordance with the situation. Note that each of the action controls 1, 2, and 4 indicates a case in which the moving speed of the drone R is high and the time interval for a state transition in the state space is less than or equal to a predetermined threshold, and the action control 3 indicates a case in which the moving speed of the drone R is not high and the time interval for a state transition in the state space is greater than a predetermined threshold. The aforementioned controls will be described below.

The action control 1 indicates a case in which it is determined that the needs for access to resources by the drone R is greater than or equal to a predetermined threshold in the needs assessment and it is determined that the risk of access to resources by the drone R is less than a first threshold Th1 in the risk assessment. In this case, the policy generation model sets an access control policy so as to permit access not only to the resource B corresponding to the area β, which is the position of the drone R recognized by the enforcer 24, but also to the resources C and D corresponding to the areas γ and δ located in the direction in which the drone R flies. As described above, it is assumed that the actual position of the drone R is moved to the area γ or δ while the enforcer 24 recognizes that the position of the drone R is in the area β. Therefore, when there are high needs for the drone R to acquire resources, it is preferable to permit access to the resources C and D.

The action control 2 indicates a case in which it is determined that the needs for access to resources by the drone R is greater than or equal to a predetermined threshold in the needs assessment and it is determined that the risk of access to resources by the drone R is greater than or equal to the first threshold Th1 and less than a second threshold Th2 (Th1 is smaller than Th2) in the risk assessment. In this case, the policy generation model sets an access control policy so as to permit access not only to the resource B corresponding to the area β, which is the position of the drone R recognized by the enforcer 24, but also to the resource C corresponding to the adjacent area γ. Note that, in the situation of the action control 2, although the needs for access to resources is high, the risk of collection of resources by the drone R is high as compared to the situation of the action control 1. As a result, resources for which access is to be authorized are reduced as compared to the case of the action control 1. Specifically, access to the resource D is denied. As described above, in the action controls 1 and 2, access to information about the area in which the device is located and its surrounding area is permitted or denied in accordance with the needs, risks, and probability of movement of the device of the access source.

The action control 3 indicates a case in which it is determined that the needs for access to resources by the drone R is greater than or equal to a predetermined threshold in the needs assessment and it is determined that the risk of access to resources by the drone R is greater than or equal to the first threshold Th1 and less than the second threshold Th2 in the risk assessment. As described above, it is considered that the enforcer 24 accurately recognizes the position of the drone R since the moving speed of the drone R is not high. Therefore, in the action control 3, access to only the resource B corresponding to the area β, which is the position of the drone R, is authorized and access to other resources is denied.

The action control 4 indicates a case in which it is determined that the needs for access to resources by the drone R is less than a predetermined threshold in the needs assessment and it is determined that the risk of access to resources by the drone R is greater than or equal to the second threshold Th2 in the risk assessment. In this case, the enforcer 24 may not accurately recognize the position of the drone R since the moving speed of the drone R is high. Further, since the needs for access is low and the risk is high, the policy generation model sets that access from the drone R to all the resources is denied. This action control 4 is set by the process (B) performed by the execution cost evaluation unit 212 described above.

As described above, in the access control system 20A, the execution cost evaluation unit 212 evaluates the execution cost when the action corresponding to the target pattern is changed over time by using the state transition model. Then the policy generation unit 213 determines an action corresponding to the target pattern by using at least a result of the evaluation and the determination sample acquired by the information acquisition unit 211. By this configuration, it is possible to generate an access control policy that not only achieves a balance between security and needs, but also satisfies the feasibility of control (i.e., makes control feasible).

For example, it is assumed that there is an action that achieves a balance between security and needs required by information (e.g., information of the determination sample or intention) acquired by the information acquisition unit 211 and that the feasibility of the action is high. In this case, the policy generation unit 213 generates an access control policy so that the action is executed.

On the other hand, it is also assumed that although there is an action that achieves a balance between security and needs required by information acquired by the information acquisition unit 211, the feasibility of the action is low. In this case, the policy generation unit 213 refers to at least either the risk assessment or the needs assessment and then generates an access control policy so that an action that satisfies one of the security and the needs is executed, while the other of security and needs is not satisfied. In this way, the access control system 20A can automatically generate, based on less-accurate samples or a small number of determination samples, an access control policy in which the trade-off among security, needs, and feasibility is taken into account.

Further, as described above, the determination unit 22 can set in the access control device (the enforcer 24) a set of a number of actions as an ACL. In this case, since the access control device can determine an action only by referring to the ACL in response to a request for access, the access control device does not need to acquire background attribute information related to the access and perform retrieval when it determines the action. Therefore, the speed of access control processing of the access control device can be increased. However, it may still be a challenge to achieve a reduction of the execution cost for generating and updating the ACL in the access control system 20A. In the second example embodiment, since an access control policy in which highly feasible actions are defined can be generated, the number of times the ACL based on the access control policy is updated can be reduced.

Further, it is assumed that when the risk of access made from the device of the access source is low (e.g., less than or equal to a predetermined threshold), the number of resources authorized by the access control policy for the access from this device will increase. For example, when the device of the access source moves as shown in the access control policies 1 and 2 in FIG. 5D, an access control policy can authorize the access to resources related to positions where the device of the access source is likely to move in the future. Therefore, the enforcer 24 can reduce the frequency of communication with the device of the access source. Further, the number of updates of the ACL can be reduced when the ACL is generated, since the feasibility of increasing the number of resources authorized for access from the device of the access source is high.

Meanwhile, access control policies may be set so as to deny access from the device in a situation where a high security risk arises and so as to authorize access in a situation where continued service to the device is necessary. For example, it is assumed that the policy generation unit 213 determines, based on the risk assessment and the needs assessment, that a security risk increases only under specific situations and the needs need to be maintained except in the specific situations. In this case, before and after a situation where a security risk increases, such access control policies that detailed access control is executed even if the frequency of updates of the ACL is increased are generated. This configuration provides, at the point when the risk of access begins to increase, the effect that access can be blocked early and thus security is ensured. Further, in a situation other the above situation, the frequency of updates of the ACL is reduced and thus the execution cost can be reduced.

Further, specifically, the information acquisition unit 211 acquires information of the intention indicating the attributes of access, in which at least one of the order and the magnitude of the degree of influence of the intention on the action is defined, and the policy generation unit 213 may generate an access control policy by further using the information of the intention. By doing so, it is possible to further enhance the accuracy of the access control policy.

Further, the policy generation unit 213 can determine an action corresponding to this pattern by further using information indicating at least one of the level of the needs of the target pattern and the level of the security of the target pattern. By this configuration, an access control policy can be generated so that it meets at least one of a viewpoint of the needs and a viewpoint of the security.

Specifically, the execution cost evaluation unit 212 can evaluate the feasibility of changing the action over time. When the evaluated feasibility is greater than or equal to a predetermined threshold, the policy generation unit 213 determines an action corresponding to the pattern so that it satisfies both the level of the needs and the level of the security required in the pattern subject to access control. On the other hand, when the evaluated feasibility is less than a predetermined threshold, the policy generation unit 213 determines, based on both the required level of the needs and the required level of security, an action corresponding to the pattern so that it satisfies one of the required level of the needs and the required level of security. By this configuration, the access control policy can reliably define actions that are realistically feasible.

Further, the execution cost evaluation unit 212 may generate a log or a model (e.g., a state transition model) showing changes in the attributes of access over time as transition information, and evaluate the execution cost using the generated transition information. By doing so, the execution cost evaluation unit 212 can evaluate the execution cost by a simple method. However, the execution cost evaluation unit 212 may acquire the above transition information from other components of the access control system.

Further, when the execution cost evaluation unit 212 determines, by referring to the transition information, that the probability that the attributes of access related to the target pattern are transitioned from a first state to a second state over time is higher than the probability that the attributes of access related to the target pattern are transitioned from the first state to a third state over time, it may evaluate the execution cost as follows. That is, when the attribute is in the first state, the execution cost is evaluated so that the execution cost of executing an action different from the action defined in the determination sample when the attribute is in the second state is higher than the execution cost of executing an action different from the action defined in the determination sample when the attribute is in the third state. By this configuration, in access control policies, actions that can be taken in a state in which a probability of transition in the near future is high are more likely to be executed, thus making it easier to acquire resources and increasing the needs.

Further, the policy generation unit 213 can determine, regarding an access in which a time interval at which the attributes of access related to the pattern subject to access control are transitioned over time from the first state to the second state is less than or equal to a predetermined threshold and an action defined in the determination sample in the first state differs from that defined in the determination sample in the second state, the action in the first state in the access and the action in the second state in the access to be the same action. By this configuration, the policy generation unit 213 can maintain, when the time interval until the transition is short and the feasibility of changing the action before and after the transition is low, the feasible actions before and after the transition. Therefore, it is possible to reduce the execution cost related to the action.

Specifically, the policy generation unit 213 may execute the above-described method for determining action by inputting a determination sample added by the execution cost evaluation unit 212 to the policy generation model. By doing so, the policy generation unit 213 can make the policy generation model learn so as to correspond to reality.

### Third Example Embodiment

A third example embodiment will disclose below a further specific example of the analysis apparatus 10 described in the first example embodiment. Note that the same description given in the second example embodiment will be omitted as appropriate.

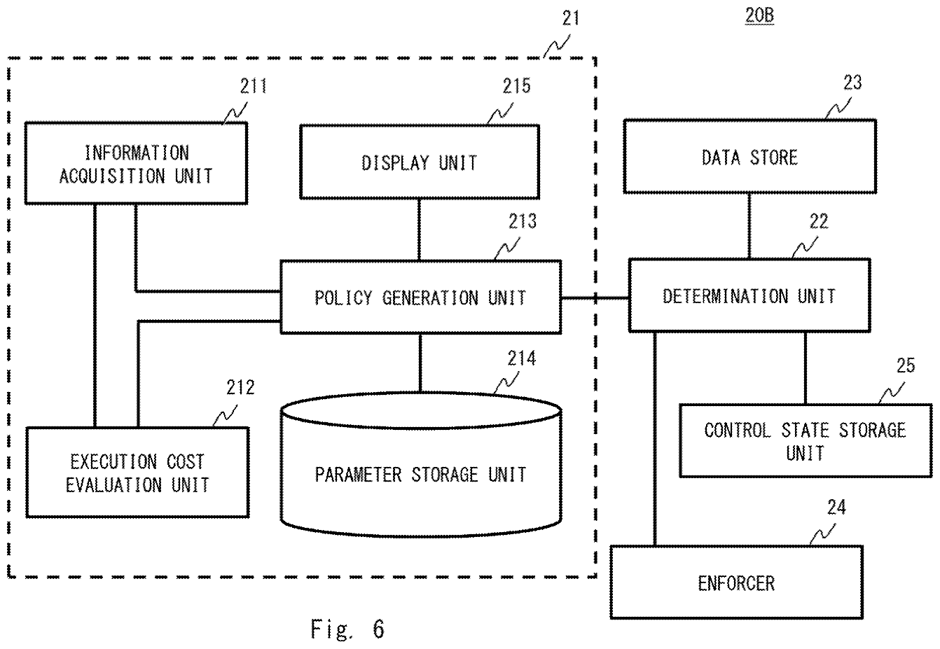

FIG. 6 is a block diagram showing an example of an access control system 20B that performs a determination of access control on a zero-trust network. The access control system 20B further includes a control state storage unit 25 in addition to the policy generation system 21, the determination unit 22, the data store 23, and the enforcer 24. The control state storage unit 25 will be described below, and only the processes performed by the policy generation system 21, the determination unit 22, the data store 23, and the enforcer 24 in this example embodiment different from those in the second example embodiment will also be described below, i.e., the descriptions of the processes performed by the above components, the processes being the same in this example embodiment and the second example embodiment, will be omitted.

The control state storage unit 25 stores a past action history determined by the determination unit 22, which is a policy engine. The past action history includes, for example, a pair of the ID of a device of the request source and the ID of the request destination. The determination unit 22 can use the action history stored in the control state storage unit 25 in order to determine an action.

In the access control system 20B, the following process (C) by the information acquisition unit 211 is executed in place of the process (A) executed by the execution cost evaluation unit 212. (C) The information acquisition unit 211 can execute at least one of the following processes with regard to at least one of the order and the magnitude of the degree of influence of the intention on the action as information of the intention in which at least one of the order and the magnitude of the degree of influence of the intention on the action is defined. That is, the aforementioned processes are to give a positive effect to a setting of the same action before and after an elapse of time and to give a negative effect to a setting of an action after an elapse of time different from an action before the elapse of time. The information acquisition unit 211 can execute the process (C) by acquiring the past action history from the control state storage unit 25 and then specifying the contents of the most recent action taken in the target pattern.

The policy generation unit 213 determines an action and generates an access control policy by further using information of the intention set by the information acquisition unit 211 through the process (C) in addition to a determination sample and the like. As described above, when the information acquisition unit 211 determines an action, it sets a qualitative effect as information of the intention so that the action taken in the most recent access control can be easily executed in the present access control. Therefore, it is possible to generate an access control policy in which the feasibility of access control is taken into account in a simpler process than the smoothing process shown in the process (A).

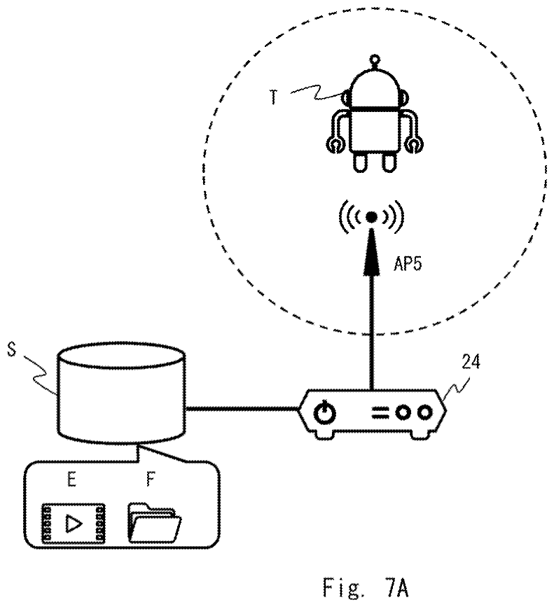

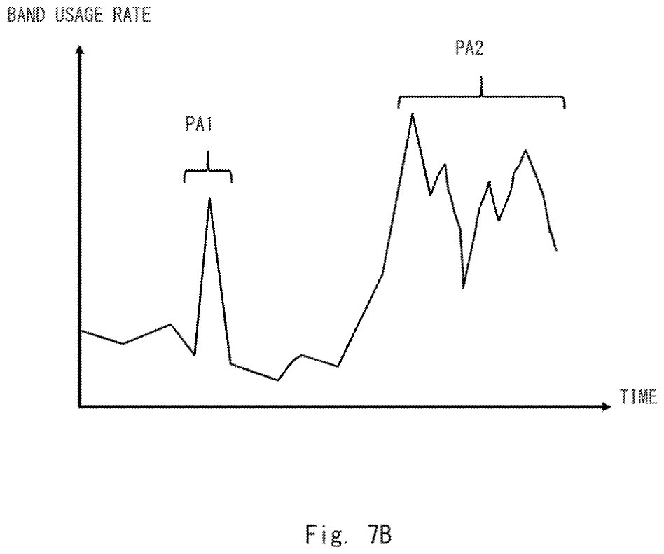

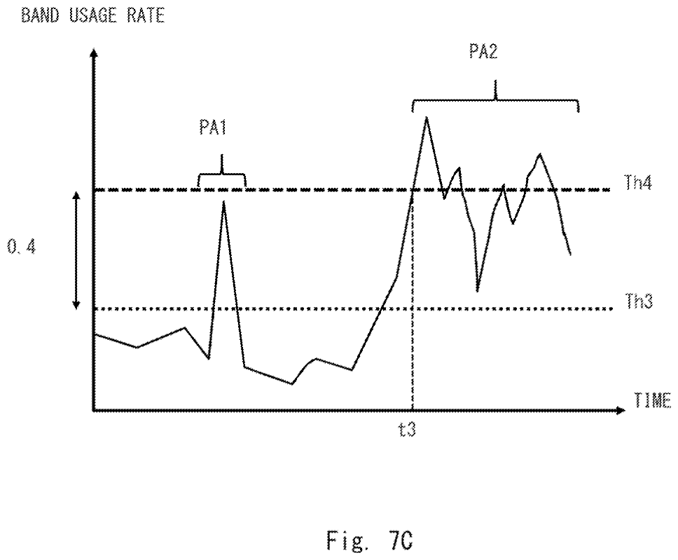

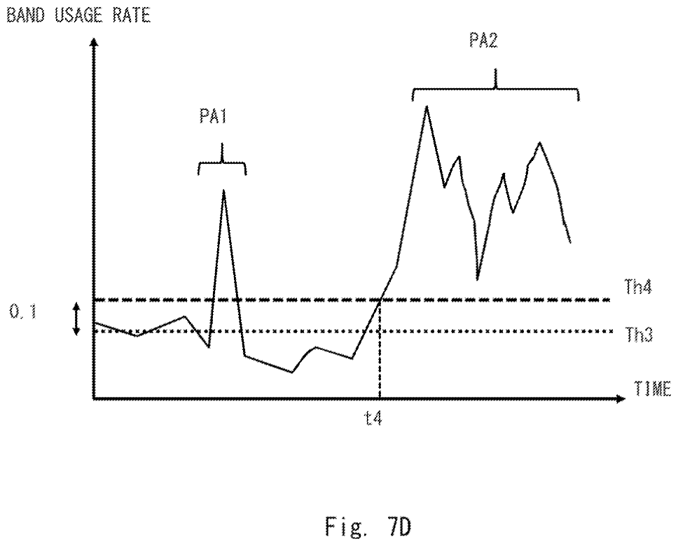

FIG. 7A is a diagram showing an example of an access control situation. In FIG. 7A, a robot T performs radio communication with an AP 5, thereby requesting resources from the enforcer 24, which is an access control device connected to the AP 5. When the enforcer 24 receives this request, it outputs attribute information of the device, such as the ID of the robot T that is the access source and the band usage rate in communication with the robot T, to the determination unit 22 (not shown in FIG. 7A). The enforcer 24 authorizes or denies access to each of resources E and F included in the resource S connected to the enforcer 24 based on an action instruction from the determination unit 22. The resource E is video content and the resource F is a text file. Therefore, a load imposed on the band usage of radio communication when the robot T accesses the resource E is larger than that when it accesses the resource F.

FIG. 7B is a graph showing an example of a band usage rate in radio communication performed by the robot T. As shown in FIG. 7B, the graph of the band usage rate has two peaks, a peak PA1 and a peak PA2, in accordance with an elapse of time. Note that the peak PA2 has a larger maximum value of the band usage rate and a longer peak period of time than those in the case of the peak PA1.

As described above, the resource E is video content. Therefore, in a case in which the band usage rate is high, when access to the resource E by the robot T is permitted, another robot may not be able to communicate with the enforcer 24. In order to solve this problem, a method for defining so that access to the resource E by the robot T is denied when one threshold for the band usage rate is defined in the access control policy and the band usage rate exceeds this threshold may be used.

However, when this method is applied in a situation where the degree of change in the band usage rate is high as shown in FIG. 7B, a state where the band usage rate exceeds a threshold and a state where it is less than or equal to a threshold are switched frequently. When the time at which this switching is performed is less than or equal to the interval (threshold) of a predetermined allowable time, the collection of information performed by the enforcer 24 or the update of the ACL given to the enforcer 24 are not be able to follow an actual change of the band usage rate. Therefore, the enforcer 24 cannot perform access control as described in the access control policy since the switching of the actions of the access control between an authorization and a denial is not in time for the actual change of the band usage rate. Thus, a security risk may arise and the service quality of radio communication may deteriorate. In order to solve this problem, when it is attempted to increase the frequency of the collection of information by the enforcer 24 or the update of the ACL given to the enforcer 24, the execution cost associated with the access control increases.

Further, a method for setting two types of thresholds Th3 and Th4 (Th4>Th3) for hysteresis in the access control policy may be used. In this case, when the band usage rate exceeds the threshold Th3 and then exceeds the threshold Th4, the state of the access to the resource E changes from an authorized state to a denied state, while when the band usage rate becomes less than or equal to the threshold Th4 and then becomes less than or equal to the threshold Th3, the state of the access to the resource E changes from a denied state to an authorized state. In this method, however, each threshold is a fixed value. Therefore, when there is an ideal policy generated in advance based on a detailed comparison between security and needs, this policy will deviate from the actual control.

Each of FIGS. 7C and 7D is a graph showing an example of action control performed in a situation of FIG. 7A by an access control policy generated by the policy generation unit 213 based on the above-described process in order to solve the above problem. FIG. 7C shows an example of an access control policy in a case in which the risk of access by the robot T evaluated by the risk assessment is less than a predetermined threshold (in a case of a medium level of risk). FIG. 7D shows an example of an access control policy when the risk of access by the robot T evaluated by the risk assessment is greater than or equal to a predetermined threshold (in a case of a high level of risk).

In FIG. 7C, the interval (hysteresis margin) between the thresholds Th3 and Th4 for hysteresis is 0.4, which is relatively long. Further, the value of Th4 is relatively large. Therefore, in the action control in FIG. 7C, access to the resource E is authorized at the peak PA1, while access to the resource E is denied at the peak PA2. Specifically, near the peak PA2 in FIG. 7C, access to the resource E is denied after a time t3 at which the band usage rate exceeds the threshold Th4. As described above, an access control policy in which a hysteresis margin is large is generated when both the risk and needs of access determined in the risk assessment and the needs assessment are less than or equal to a predetermined threshold. By this configuration, frequent changes of actions can be reduced, and thus the execution cost can be reduced. Further, when the access control system 20 generates an ACL, the frequency of updates of the ACL can be reduced.

In FIG. 7D, the interval (hysteresis margin) between thresholds Th3 and Th4 for hysteresis is 0.1, which is relatively short. Further, Th3 and Th4 in FIG. 7D are smaller than Th3 and Th4 in FIG. 7C, respectively (In this example, Th4 in FIG. 7D is equal to Th3 in FIG. 7C). Therefore, in the action control in FIG. 7D, access to the resource E is denied at the peaks PA1 and PA2. Specifically, near the peak PA2 in FIG. D, access to the resource E is denied after a time t4 at which the band usage rate exceeds the threshold Th4. At this time, since the time t4 is earlier than the time t3, in the situation shown in FIG. 7D, access to the resource E is denied for a longer time than in the situation shown in FIG. 7C. As described above, an access control policy in which a hysteresis margin is small is generated when at least one of the risk of access determined in the risk assessment and the needs of access determined in the needs assessment is higher than a predetermined threshold. By this configuration, since actions can be controlled in a detailed manner, access control based on the required risk or needs can be performed. Further, when the access control system 20 generates an ACL, the frequency of updates of the ACL can be reduced.

As described above, in the access control system 20B, the information acquisition unit 211 can execute at least one of the following processes with regard to at least one of the order and the magnitude of the degree of influence of the intention on the action as information of the intention: to give a positive effect to a setting of the same action before and after an elapse of time and to give a negative effect to a setting of an action after an elapse of time different from an action before the elapse of time. The policy generation unit 213 generates an access control policy by using the information of the intention to which at least one of the positive effect and the negative effect is applied. By this configuration, it is possible to generate an access control policy that not only achieves a balance between security and needs, but also satisfies the feasibility of control.

Specifically, the policy generation unit 213 can automatically generate access control policies (e.g., policies having different thresholds and hysteresis margins for determination) different when at least one of the required risk and needs of access is high and when the required risk and the needs of access are both low. By this configuration, the flexibility in access control can be increased, and it is thus possible to contribute to the reduction of the execution cost associated with the access control as much as possible while maintaining the required security and needs.

Further, the process (A) in the second example embodiment is an internal process executed by the execution cost evaluation unit 212. In contrast, a history of the actions taken in the most recent access control is used in the process (C) in the third example embodiment. Therefore, when a user adjusts the method of the process (A) or (C), the user can more easily check the action history than the result of the internal process executed by the execution cost evaluation unit 212. Therefore, in the process (C), it is easier for a user to have understanding necessary to correct the access control policy and perform processes for this correction than in the process (A).

Since effects of the access control system 20B other than the above ones are similar to those of the access control system 20A, the descriptions thereof will be omitted.

The access control system 20 described in the second and the third example embodiments can design an access control policy having a high flexibility in control in the fields of, for example, Cyber-Physical System (CPS) and Beyond 5G. As a further specific example, the access control system 20 is useful to generate, in a synchronous CPS where a large number of devices are connected and a state continues to change dynamically, a zero-trust platform that constantly collects various types of information about devices and environments and performs access control. When the above access control is performed, attribute information such as a position of the apparatus and a use application changes frequently. However, since the processes of the access control in the access control device cannot keep up with it, action control in accordance with a policy generated in advance may not be performed. When, in order to solve this problem, the collection of information, the update of the ACL of the access control device, and the like are performed frequently, a problem that the execution cost associated with the access control becomes too high to be worth the result will occur. However, the access control system 20 according to the present disclosure can generate in advance a highly feasible access control policy in which the execution cost of the access control does not become excessive while needs and risks in the action are taken into account.

Note that the present disclosure is not limited to the above-described example embodiments and may be changed as appropriate without departing from the spirit of the present disclosure. For example, in the second example embodiment or the third example embodiment, the policy generation unit 213 can determine an action so that one of the needs defined in the needs assessment and the security defined in the risk assessment in the access pattern subject to access control is satisfied instead of determining an action so that both of the aforementioned needs and security are satisfied.

Although the present disclosure has been described as a hardware configuration in the above example embodiments, the present disclosure is not limited thereto. In the present disclosure, the processes (steps) performed by the policy generation apparatus or the policy generation system described in the above example embodiments can also be implemented by causing a processor in the computer to execute a computer program.

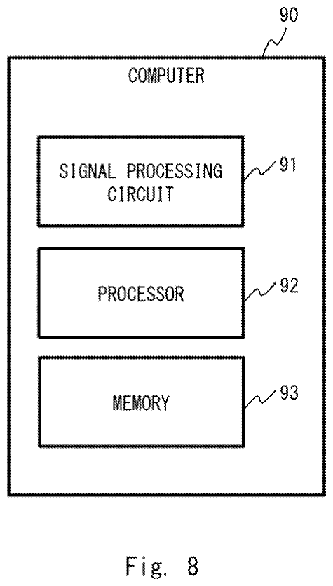

FIG. 8 is a block diagram showing an example of a hardware configuration of an information processing apparatus (a signal processing apparatus) in which processes performed in the above example embodiments are executed. As shown in FIG. 8, this information processing apparatus 90 includes a signal processing circuit 91, a processor 92, and a memory 93.

The signal processing circuit 91 is a circuit for processing a signal in accordance with control of the processor 92. Note that the signal processing circuit 91 may include a communication circuit that receives a signal from a transmission apparatus.

The processor 92 is connected (coupled) to the memory 93 and performs processes performed by the apparatus described in the above-described example embodiments by loading software (a computer program) from the memory 93 and executing the loaded software. As an example of the processor 92, one of a Central Processing Unit (CPU), a Micro Processing Unit (MPU), Field-Programmable Gate Array (FPGA), a Demand-Side Platform (DSP), and an Application Specific Integrated Circuit (ASIC) may be used, or a plurality of these processors may be used in parallel.

The memory 93 is composed of a volatile memory or a nonvolatile memory, or a combination thereof. The number of the memory 93 is not limited to one, and a plurality of memories 93 may instead be provided. Note that the volatile memory may be, for example, a Random Access Memory (RAM) such as a Dynamic Random Access Memory (DRAM) and a Static Random Access Memory (SRAM). The nonvolatile memory may be, for example, a Read Only Memory (ROM) such as a Programmable Random Only Memory (PROM) and an Erasable Programmable Read Only Memory (EPROM), a flash memory, or a Solid State Drive (SSD).

The memory 93 is used to store one or more instructions. Note that one or more instructions are stored in the memory 93 as a group of software modules. The processor 92 can perform the processes described in the above-described example embodiments by loading the group of software modules from the memory 93 and executing the loaded group of software modules.

Note that, in addition to those provided outside the processor 92, the memory 93 may include those built in the processor 92. The memory 93 may also include a storage located apart from the processors comprising the processor 92. In this case, the processor 92 can access the memory 93 through an Input/Output (I/O) interface.

As described above, one or a plurality of processors included in the apparatuses in the above-described example embodiments execute one or a plurality of programs including instructions for causing a computer to perform the algorithm described with reference to the drawings. Through the above processes, the signal processing method described in each of the example embodiments can be implemented.

The program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### (Supplementary Note 1)

An analysis apparatus comprising:
acquisition means for acquiring at least a data set in which a plurality of combinations of a first pattern of one or more elements indicating attributes of access and an action of access control corresponding to the first pattern are defined, and a second pattern of one or more elements indicating attributes of access that change over time;
evaluation means for evaluating an execution cost when an action corresponding to the second pattern is changed over time by using at least transition information indicating a state transition in the one or more elements indicating attributes of access, and the second pattern; and
determination means for determining the action corresponding to the second pattern by using at least a result of the evaluation by the evaluation means and the data set.

### (Supplementary Note 2)

The analysis apparatus according to Supplementary Note 1, wherein
the acquisition means further acquires a third pattern of one or more elements indicating attributes of access, the third pattern defining at least one of an order of degree of influence of the elements on the action and a magnitude of degree of influence of the elements on the action, and
the determination means determines the action by further using the third pattern.

### (Supplementary Note 3)

The analysis apparatus according to Supplementary Note 2, wherein
in the third pattern, the acquisition means executes, with regard to at least one of the order of degree of influence on the action and the magnitude of degree of influence on the action, at least one of a process of giving a positive effect to a setting of the same action before and after an elapse of time and a process of giving a negative effect to a setting of an action after an elapse of time different from an action before the elapse of time, and
the determination means determines the action by further using the third pattern to which at least one of the positive effect and the negative effect is given.

### (Supplementary Note 4)

The analysis apparatus according to any one of Supplementary notes 1 to 3, wherein the determination means determines the action corresponding to the second pattern by further using information indicating at least one of a level of needs required in the second pattern and a level of security required in the second pattern.

### (Supplementary Note 5)

The analysis apparatus according to Supplementary Note 4, wherein
the evaluation means further evaluates feasibility of changing an action over time, and
the determination means determines, when the feasibility evaluated by the evaluation means is greater than or equal to a predetermined threshold, the action corresponding to the second pattern so that it satisfies both the level of needs required in the second pattern and the level of security required in the second pattern, and
when the feasibility evaluated by the evaluation means is less than a predetermined threshold, the determination means determines, based on both the level of needs required in the second pattern and the level of security required in the second pattern, whether the level of needs required in the second pattern or the level of security required in the second pattern is to be satisfied, and then determines the action corresponding to the second pattern so that the determined level is satisfied.

### (Supplementary Note 6)

The analysis apparatus according to any one of Supplementary notes 1 to 3, wherein the evaluation means acquires or generates, as the transition information, a log or a model indicating a change of the attributes of access over time, and evaluates the execution cost by using at least the transition information and the second pattern.

### (Supplementary Note 7)

The analysis apparatus according to Supplementary Note 1 or 2, wherein in a case in which the evaluation means determines, by referring to the transition information, that a probability that the attributes of access related to the second pattern are transitioned over time from a first state to a second state is higher than a probability that the attributes of access related to the second pattern are transitioned over time from the first state to a third state, the evaluation means evaluates, when the attributes are in the first state, the execution cost so that the execution cost of executing an action different from the action defined in the data set when the attributes are in the second state is higher than the execution cost of executing an action different from the action defined in the data set when the attributes are in the third state.

### (Supplementary Note 8)

The analysis apparatus according to any one of Supplementary notes 1 to 3, wherein the determination means determines, regarding an access in which a time interval at which the attributes of access related to the second pattern are transitioned over time from a first state to a second state is less than or equal to a predetermined threshold and an action defined in the data set in the first state differs from that defined in the data set in the second state, the action in the first state in the access and the action in the second state in the access to be the same action.

### (Supplementary Note 9)

The analysis apparatus according to any one of Supplementary notes 1 to 3, wherein
the determination means determines the action corresponding to the second pattern by using a model trained so that it outputs the action corresponding to the second pattern by inputting at least the result of the evaluation and the data set, and
regarding an access in which a time interval at which the attributes of access related to the second pattern are transitioned over time from a first state to a second state is less than or equal to a predetermined threshold and an action defined in the data set in the first state differs from that defined in the data set in the second state, the determination means inputs, to the model as the data set, data in which the action in the first state in the access and the action in the second state in the access are defined as being the same action.

### (Supplementary Note 10)

An analysis method executed by a computer, the analysis method comprising:
acquiring at least a data set in which a plurality of combinations of a first pattern of one or more elements indicating attributes of access and an action of access control corresponding to the first pattern are defined, and a second pattern of one or more elements indicating attributes of access that change over time;
evaluating an execution cost when an action corresponding to the second pattern is changed over time by using at least transition information indicating a state transition in the one or more elements indicating attributes of access, and the second pattern; and
determining the action corresponding to the second pattern by using at least a result of the evaluation and the data set.

### (Supplementary Note 11)

A non-transitory computer readable medium storing a program for causing a computer to:
acquire at least a data set in which a plurality of combinations of a first pattern of one or more elements indicating attributes of access and an action of access control corresponding to the first pattern are defined, and a second pattern of one or more elements indicating attributes of access that change over time;
evaluate an execution cost when an action corresponding to the second pattern is changed over time by using at least transition information indicating a state transition in the one or more elements indicating attributes of access, and the second pattern; and
determine the action corresponding to the second pattern by using at least a result of the evaluation and the data set.

Although the present disclosure has been described above with reference to example embodiments, the present disclosure is not limited to the above-described example embodiments. Various changes that can be understood by those skilled in the art can be made to the configuration and details of the present disclosure within the scope of the disclosure.

### REFERENCE SIGNS LIST

10 ANALYSIS APPARATUS
11 ACQUISITION UNIT
12 EVALUATION UNIT
13 DETERMINATION UNIT
20 ACCESS CONTROL SYSTEM
21 POLICY GENERATION SYSTEM
22 DETERMINATION UNIT
23 DATA STORE
24 ENFORCER
25 CONTROL STATE STORAGE UNIT
211 INFORMATION ACQUISITION UNIT
212 EXECUTION COST EVALUATION UNIT
213 POLICY GENERATION UNIT
214 PARAMETER STORAGE UNIT
215 DISPLAY UNIT

What is claimed is:

1. An analysis apparatus comprising:
at least one memory configured to store instructions; and
at least one processor configured to execute the instructions to:
acquire at least a data set in which a plurality of combinations of a first pattern of one or more elements indicating attributes of access and an action of access control corresponding to the first pattern are defined, and a second pattern of one or more elements indicating attributes of access that change over time;
evaluate an execution cost when an action corresponding to the second pattern is changed over time by using at least transition information indicating a state transition in the one or more elements indicating attributes of access, and the second pattern; and
determine the action corresponding to the second pattern by using at least a result of the evaluation and the data set.

2. The analysis apparatus according to claim 1, wherein the at least one processor is further configured to:
acquire a third pattern of one or more elements indicating attributes of access, the third pattern defining at least one of an order of degree of influence of the elements on the action and a magnitude of degree of influence of the elements on the action, and
determine the action by further using the third pattern.

3. The analysis apparatus according to claim 2, wherein the at least one processor is further configured to:
in the third pattern, execute, with regard to at least one of the order of degree of influence on the action and the magnitude of degree of influence on the action, at least one of a process of giving a positive effect to a setting of the same action before and after an elapse of time and a process of giving a negative effect to a setting of an action after an elapse of time different from an action before the elapse of time, and
determine the action by further using the third pattern to which at least one of the positive effect and the negative effect is given.

4. The analysis apparatus according to claim 1, wherein the at least one processor is further configured to determine the action corresponding to the second pattern by further using information indicating at least one of a level of needs required in the second pattern and a level of security required in the second pattern.

5. The analysis apparatus according to claim 4, wherein the at least one processor is further configured to:
evaluate feasibility of changing an action over time, and
determine, when the feasibility is greater than or equal to a predetermined threshold, the action corresponding to the second pattern so that it satisfies both the level of needs required in the second pattern and the level of security required in the second pattern, and
when the feasibility is less than a predetermined threshold, determine, based on both the level of needs required in the second pattern and the level of security required in the second pattern, whether the level of needs required in the second pattern or the level of security required in the second pattern is to be satisfied, and then determines the action corresponding to the second pattern so that the determined level is satisfied.

6. The analysis apparatus according to claim 1, wherein the at least one processor is further configured to acquire or generate, as the transition information, a log or a model indicating a change of the attributes of access over time, and evaluate the execution cost by using at least the transition information and the second pattern.

7. The analysis apparatus according to claim 1, wherein in a case in which the at least one processor determines, by referring to the transition information, that a probability that the attributes of access related to the second pattern are transitioned over time from a first state to a second state is higher than a probability that the attributes of access related to the second pattern are transitioned over time from the first state to a third state, the at least one processor is further configured to evaluate, when the attributes are in the first state, the execution cost so that the execution cost of executing an action different from the action defined in the data set when the attributes are in the second state is higher than the execution cost of executing an action different from the action defined in the data set when the attributes are in the third state.

8. The analysis apparatus according to claim 1, wherein the at least one processor is further configured to determine, regarding an access in which a time interval at which the attributes of access related to the second pattern are transitioned over time from a first state to a second state is less than or equal to a predetermined threshold and an action defined in the data set in the first state differs from that defined in the data set in the second state, the action in the first state in the access and the action in the second state in the access to be the same action.

9. The analysis apparatus according to claim 1, wherein the at least one processor is further configured to:
determine the action corresponding to the second pattern by using a model trained so that it outputs the action corresponding to the second pattern by inputting at least the result of the evaluation and the data set, and
regarding an access in which a time interval at which the attributes of access related to the second pattern are transitioned over time from a first state to a second state is less than or equal to a predetermined threshold and an action defined in the data set in the first state differs from that defined in the data set in the second state, input, to the model as the data set, data in which the action in the first state in the access and the action in the second state in the access are defined as being the same action.

10. An analysis method executed by a computer, the analysis method comprising:
acquiring at least a data set in which a plurality of combinations of a first pattern of one or more elements indicating attributes of access and an action of access control corresponding to the first pattern are defined, and a second pattern of one or more elements indicating attributes of access that change over time;
evaluating an execution cost when an action corresponding to the second pattern is changed over time by using at least transition information indicating a state transition in the one or more elements indicating attributes of access, and the second pattern; and
determining the action corresponding to the second pattern by using at least a result of the evaluation and the data set.

11. A non-transitory computer readable medium storing a program for causing a computer to:
acquire at least a data set in which a plurality of combinations of a first pattern of one or more elements indicating attributes of access and an action of access control corresponding to the first pattern are defined, and a second pattern of one or more elements indicating attributes of access that change over time;
evaluate an execution cost when an action corresponding to the second pattern is changed over time by using at least transition information indicating a state transition in the one or more elements indicating attributes of access, and the second pattern; and
determine the action corresponding to the second pattern by using at least a result of the evaluation and the data set.
